(19) United States
(12) Patent Application Publication
(10) Pub. No.: US 2002/0147683 A1
(43) Pub. Date: Oct. 10, 2002

(54) Method for purchasing web based digital media

(76) Inventors: Anthony Capobianco, Cape Coral, FL (US); John Timothy Nolan, Cape Coral, FL (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/827,959

(22) Filed: Apr. 6, 2001

(51) Int. Cl. G06F 17/60

(52) U.S. Cl. 705/41

(57) ABSTRACT

A computer-assisted method of tracking a balance amount associated with a prepaid card for purchasing digital music is disclosed. The disclosed method includes, via a processor, populating a database with a unique identifier associated with a prepaid card for purchasing digital music. The disclosed method further includes, upon a sale of said prepaid card, associating an initial amount and a personal identifier with the unique identifier in the database, upon receiving a card verification request, verifying said unique identifier, upon receiving a personal verification request, verifying said personal identifier, upon receiving a balance verification request, verifying a balance amount of said prepaid card, and upon receiving transaction information regarding a transaction involving said prepaid card, adjusting said initial amount by a transaction amount corresponding to said transaction to create said balance amount.

### BACKGROUND OF THE INVENTION

The present invention relates generally to methods, systems and devices for purchasing music and video electronically, and more particularly to methods, systems and devices for purchasing music and video in digital format over a large distributed computer network, such as the Internet.

Currently, all music bought online must be bought with a credit card. Many individuals for reasons of age or economic circumstances do not have access to a credit card. Those without credit cards, such as minors or cash paying individuals therefore cannot purchase music online. As these individuals cannot purchase the music they desire, some may be inclined to obtain this music illegally.

Embodiments of the present invention are therefore directed to the problem of developing a method, system and device for procuring music stored in a digital format.

### SUMMARY OF THE INVENTION

Embodiments of the present invention can solve this and other problems by providing a prepaid digital music and/or video card similar to prepaid telephone cards of today. This can allow customers to buy one or more digital songs and/or videos to be downloaded at some point in the future.

Embodiments of the invention can enable a minor or other non-credit card owner to download digital music and/or other digital content by purchasing a pre-paid music/video card or obtaining one through a promotion. This card can enable them to download any music or content up to the limit of the card on all sites that honor it.

Embodiments of methods of he present invention can allow World Wide Web users to purchase specific audio and/or video content by means of a prepaid access card. Web sites that honor this transaction method would benefit from a wide customer base.

### BRIEF DESCRIPTION OF THE DRAWINGS

FIG. 1 is a flowchart of an exemplary embodiment of a method 100 of the present invention.

FIG. 2 is a flowchart of an exemplary embodiment of a method 200 of the present invention.

FIG. 3 is a flowchart of an exemplary embodiment of a method 300 of the present invention.

FIG. 4 is a flowchart of an exemplary embodiment of a method 400 of the present invention.

FIG. 5 is a flowchart of an exemplary embodiment of a method 500 of the present invention.

FIG. 6 is a block diagram of an exemplary embodiment of a system 600 of the present invention.

FIG. 7 is a block diagram of an embodiment of a typical information device 700 of the present invention.

### DETAILED DESCRIPTION

Currently, the purchase of digital music or video content via the Internet requires using a credit card or other prearranged payment method. Each of these methods requires the buyer to have an established credit card with an available amount of credit. Embodiments of the present invention can allow for a prepaid card to be used to procure and download music or video content to the limit of the card. The card can be used with on-line stores or content providers as well as standard retail outlets.

Embodiments of the present invention also include a system to provide for and use a pre-purchased card having an identity number to purchase digital music or video media content. The system can allow the card purchaser to select his or her own prepaid limit. This inventive system has the capacity to carry out the necessary transactions to check the available balance on the prepaid card and deduct a transaction amount from the balance in real time. Each content provider can have the capability to verify the user, verify the card, create or update the card balance with an amount requested by the user, calculate the amount revalued to the card and forward the amounts revalued to the cards for subsequent credit verification and storage by a central computer.

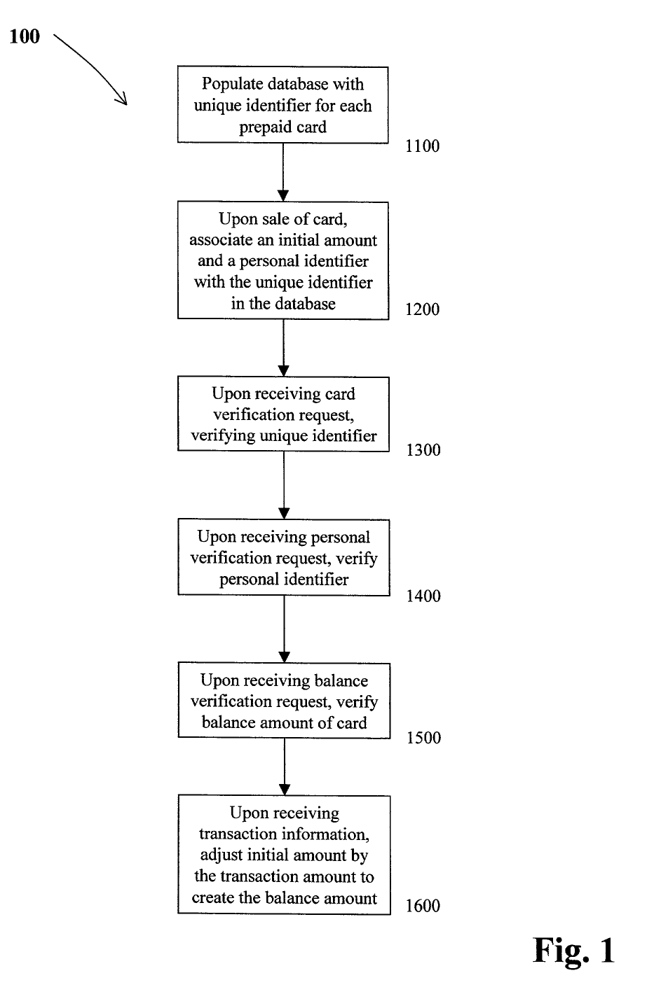

Turning to the drawings, FIG. 1 is a flowchart of an exemplary embodiment of a method 100 of the present invention. Method 100 is primarily directed to the tracking and/or verification of activities involving a prepaid card for procuring digital music. At activity 1100, a central and/or distributed database is populated with a plurality of unique identifiers, each corresponding to a single prepaid card. At activity 1200, upon a sale of a prepaid card, an initial amount and a personal identifier are associated with the unique identifier in the database.

At activities 1300-1500, upon receiving a verification request, at least one of the unique identifier, the personal identifier, and the balance amount can be verified. For example, the unique identifier associated with a card can be verified by sending the unique identifier to a server associated with the database. Software resident on the server can search the database, confirm that the unique identifier does belong to an issued card, and send a notification to that effect to the party seeking verification of the unique identifier. As another example, verification can be sought that a card has been presented by its rightful purchaser. This can be accomplished by sending the card's unique identifier and the personal identifier to a server associated with the database. Software resident on the server can search the database, confirm that the unique identifier and the personal identifier match a record in the database, and send a notification that the card is valid and the personal identifier presented matches the personal identifier associated with the unique identifier in the database. As yet another example, the unique identifier can be sent and a notification can be returned that identifies the personal identifier and/or balance amount associated in the database with the unique identifier.

At activity 1600, upon receiving transaction information that includes a transaction amount, the balance amount associated with a card can be adjusted to reflect the transaction amount. For example, when a card is first used for a purchase transaction, the initial amount of the database can be reduced by the amount of the purchase to arrive at a balance amount. Thenceforth, each additional transaction can cause the balance amount to be adjusted by the transaction amount associated with that transaction.

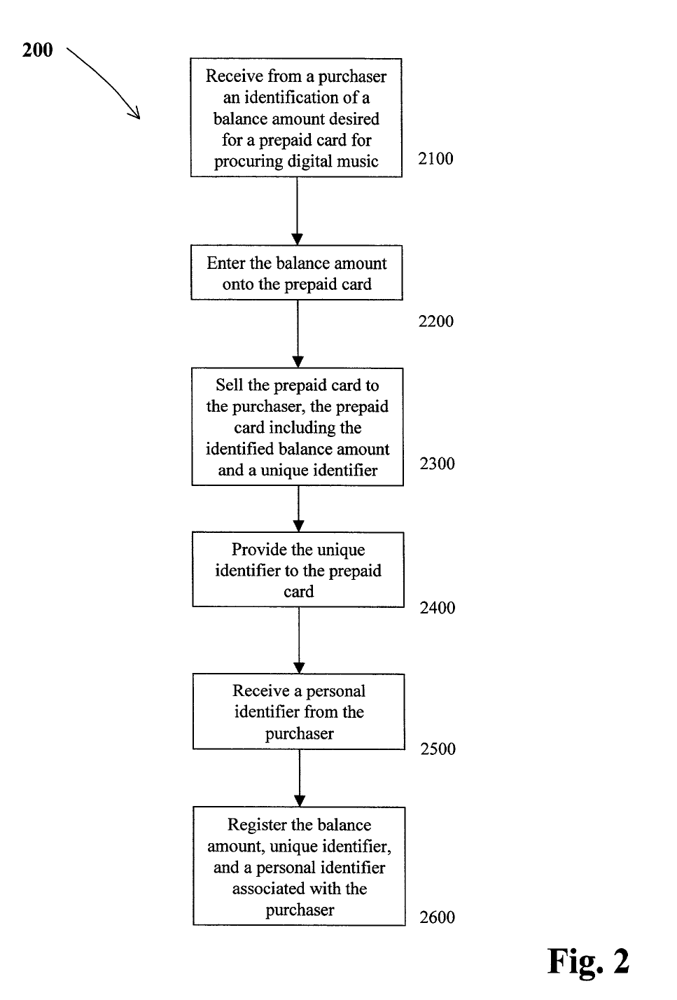

FIG. 2 is a flowchart of an exemplary embodiment of a method 200 of the present invention. Method 200 is primarily directed to the sale of a prepaid card for procuring digital music. At activity 2100, a card seller receives from a card purchaser an identification of an initial balance amount desired for the prepaid card. At activity 2200, the desired balance amount is entered onto the prepaid card. Additionally, or alternatively, the desired balance amount can be sent to a database, along with the card's unique identifier. At activity 2300, the card can be sold to the purchaser, the card containing the desired balance amount and a unique identifier. At activity 2400, the purchaser can provide a personal identifier to be associated with the card. This personal identifier can be entered onto the card by the purchaser or the seller. At activity 2500, the unique identifier can be transmitted to the database. Also, the balance amount and/or the personal identifier can be transmitted to the database to be associated with the unique identifier of the card.

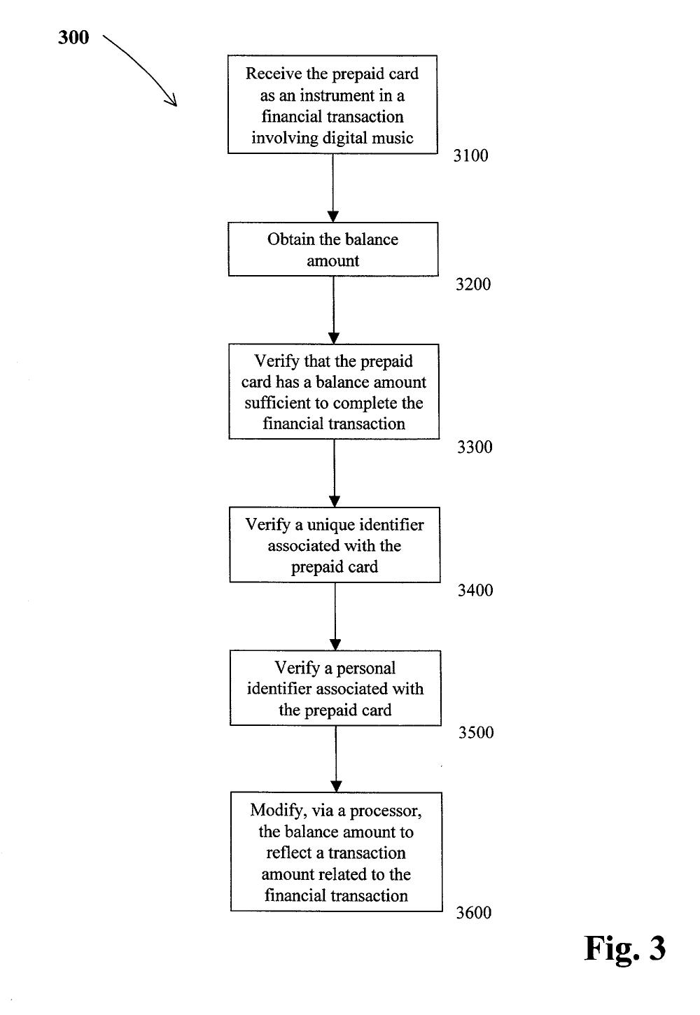

FIG. 3 is a flowchart of an exemplary embodiment of a method 300 of the present invention. Method 300 is primarily directed to the receiving the prepaid card as payment for the provision of digital music. At activity 3100, a digital music merchant receives the prepaid card as an instrument in a financial transaction involving digital music. For example, the merchant could receive the card for a sale of digital music contained on a medium such as a CD, tape, and/or DVD. As another example, the merchant could receive the card for licensing the card user right to download and play for a defined number of occurrences certain digital music from the merchant's or another's web site.

At activity 3200, the merchant can obtain the balance amount of the card. This information can be obtained from the card itself, or by accessing a database using the card's unique identifier to locate a record in the database containing the card's balance amount.

At activity 3300, the merchant can verify that the card has a sufficient balance to complete the transaction. At activity 3400, the merchant can verify the unique identifier associated with the card, thereby verifying that the card is valid. For example, the merchant can read, via the unaided eye or using a mechanical, electronic, and/or optical device, the card's unique identifier. Under one approach, the unique identifier can be compared, either manually or automatically, to a list of unique identifiers that is local to the merchant. Under another approach, the unique identifier can be sent to a server that can access the database to determine if the unique identifier is resident therein.

At activity 3500, a personal identifier associated with the card can be verified. The personal identifier can be contained on the card and/or in a database.

At activity 3600, the card's balance amount can be modified to reflect a transaction amount of the transaction. This balance amount can be recorded on the card and/or transmitted for recording in the database.

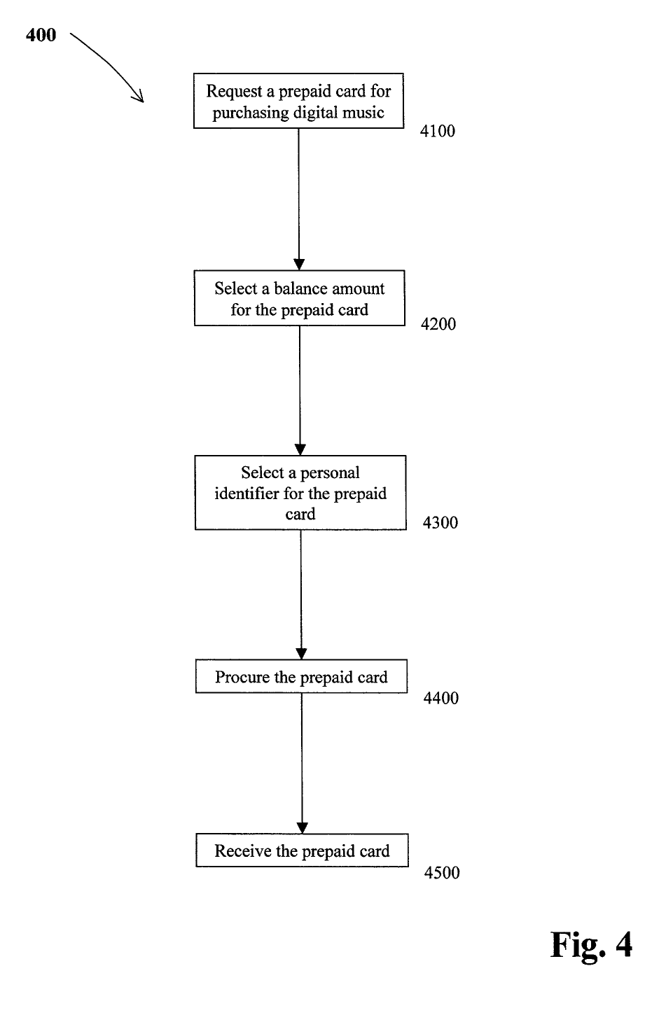

FIG. 4 is a flowchart of an exemplary embodiment of a method 400 of the present invention. Method 400 is primarily directed to the obtaining a prepaid card for procuring digital music. At activity 4100, a prepaid card for procuring digital music is requested by, for example, a purchaser of the card. At activity 4200, an initial balance amount is selected for the prepaid card. The initial balance amount can be requested at the time the prepaid card is requested, or can be selected at a later time. At activity 4300, a personal identifier for the prepaid card can be selected, requested, and/or provided to a provider of the prepaid card. At activity 4400, the prepaid card can be procured by, for example, providing payment in exchange for the prepaid card. Payment can be made by any known method. At activity 4500, the prepaid card can be provided to the procurer.

By way of example, a prepaid card can be ordered via telephone, fax, e-mail, and/or web page submission. Payment can be provided at the time of ordering, or some later time, such as at delivery. The balance amount can be requested at the time of ordering, or can be requested at a later time, such as at the time of payment. Similarly, the personal identifier can be requested, selected, identified and/or communicated at the time of ordering, or at a later time, such as at the time of payment.

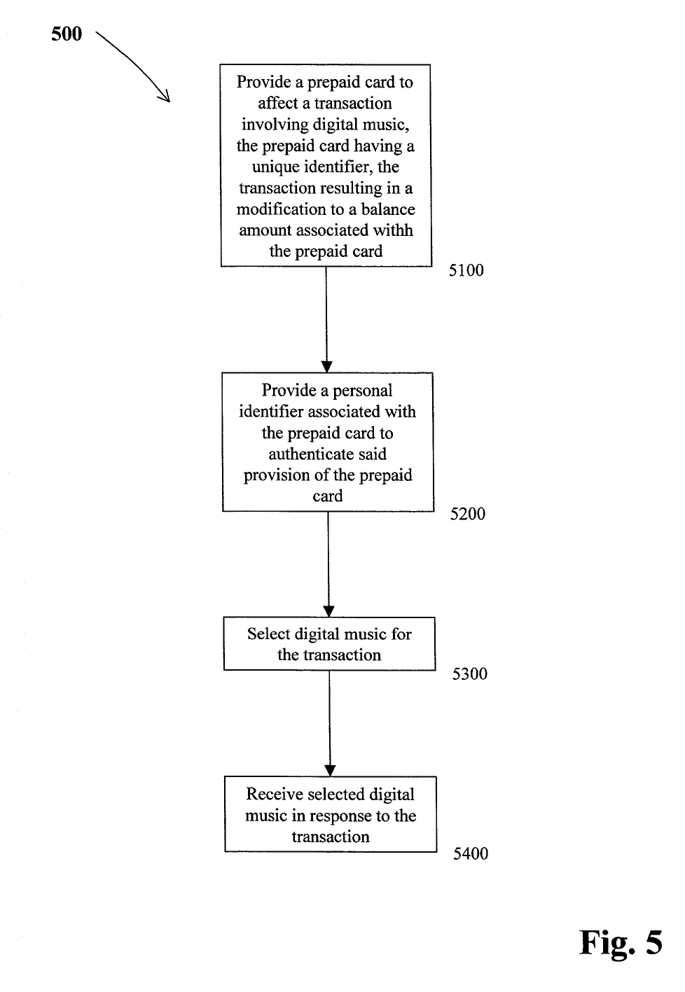

FIG. 5 is a flowchart of an exemplary embodiment of a method 500 of the present invention. Method 500 is primarily directed to procuring digital music using a prepaid card. At activity 5100, a prepaid card can be provided in a financial transaction involving digital music. The prepaid card can have a unique identifier, a balance amount, and/or a personal identifier. The transaction can result in a modification of the balance amount of the prepaid card by an amount equal to and/or associated with the transaction amount. For example, the balance amount can be reduced by a sale amount, and by a transaction processing fee for using the prepaid card.

At activity 5200, a personal identifier that is associated with the prepaid card can be provided to authenticate that the user of the prepaid card is an authorized, registered, and/or bona fide user. At activity 5300, digital music for the transaction can be requested, selected, identified, and/or communicated. At activity 5400, the requested, selected, identified, and/or communicated digital music can be received by the prepaid card user as an outcome and/or result of the transaction. Such digital music can be received as media-less digital data via downloading or file transfer, and can be received in a compressed and/or encrypted format. Alternatively, the digital music can be received pre-recorded on any known media such as, for example, floppy disk, hard disk, Zip disk, CD, DVD, digital tape, Flash ROM, Memory Stick, etc.

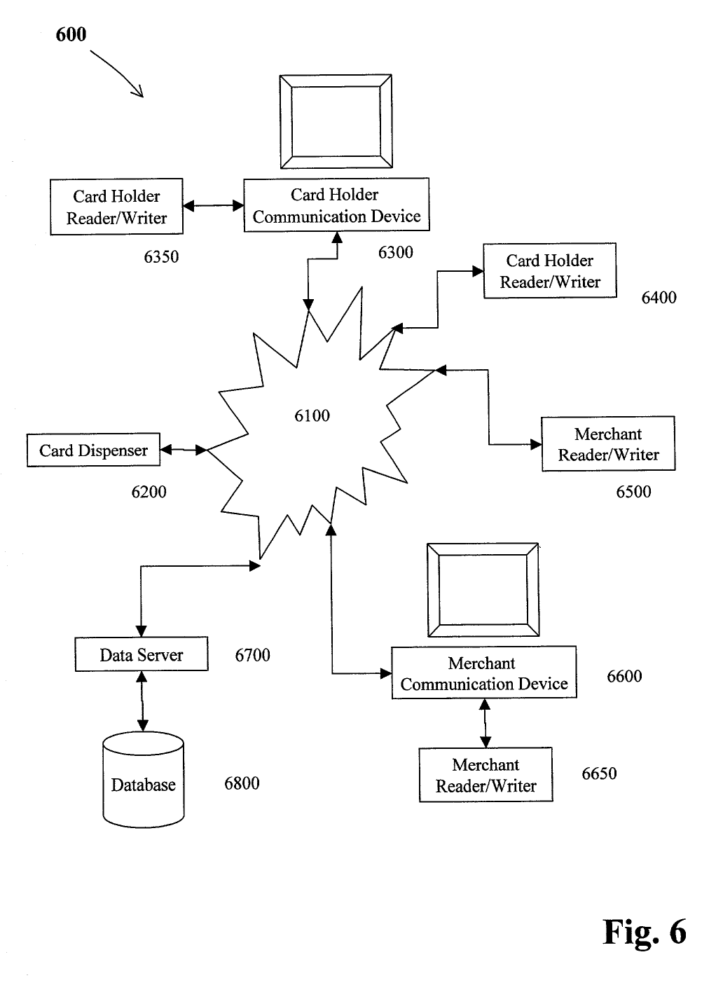

FIG. 6 is a block diagram of an exemplary embodiment of a system 600 of the present invention. As an initial matter, it suffices to say that, using the description of methods 100 through 500, one of ordinary skill in the art can implement the functionality of any of methods 100 through 500 via system 600 utilizing any of a wide variety of well-known architectures, hardware, protocols, and/or software. Thus, the following description of system 600 can be viewed as illustrative, and should not be construed to limit the implementation of any of methods 100 through 500.

Referring to FIG. 6, to network 6100 can be coupled a number of information devices, including card dispenser 6200, cardholder's communication device 6300, cardholder's card reader/writer 6400, merchant's card reader/writer 6500, merchant's communication device 6600, and/or data server 6700. To each communication device 6300, 6500, a card reader/writer 6350, 6550 can be coupled. To data server 6700, a database 6800 can be coupled.

Card dispenser 6200 can be used for procuring the card. Such a dispenser can be located nearly anywhere, including for example, at a retail establishment, within an ATM, near vending machines, in residential locations, etc.

Cardholder's communication device 6300, coupled card reader/writer 6350, and/or cardholder's card reader/writer 6400 can be also be used for procuring a card, for procuring digital music using the card, changing the personal identifier of the card user, obtaining the balance amount of the card, and/or for requesting, receiving, and/or viewing a transaction history involving the card.

Depending on how it is configured, any device designated herein as a card reader/writer can function solely as a card reader, solely as a card writer, or can function as both. Any device designated herein as a communication device can, in some embodiments, be used to download, record, and/or decrypt digital music.

Merchant's card reader/writer 6500, merchant's communication device 6600, and/or coupled card reader/writer 6650 can be used for procuring digital music using the card, changing the personal identifier of the card user, obtaining the balance amount of the card, and/or for requesting a transaction history involving the card.

Data server 6700 can be used to host one or more databases 6800, serve files, serve e-mail, etc. Data server 6700 can be a computing device of any sort. Similarly, any of information devices 6200-6650 can be used to host one or more databases (not shown).

Database 6800 can be used for recording and providing information regarding a card. For example, for a given card, database 6800 can register, include, and/or verify the card's unique identifier, personal identifier, initial balance amount, current balance amount, and/or information regarding each transaction involving the card, etc. Any and/or all of this information can be provided to any of devices 6200-6650.

Network 6100 can electronically link physically distant information devices 6200-6650, and data server 6700, so that information can be transmitted and/or exchanged there between. Network 6100 can have any architecture, including a direct connection, a local area network, a wide area network such as the public switched telephone network and/or the Internet, an extranet, and/or a combination thereof. Network 6100 can be a packet-switched, a circuit-switched, a connectionless, or connection-oriented network or interconnected networks, or any combination thereof. Network 6100 can be oriented toward voice, data, or voice and data communications. Moreover, a transmission media of network 6100 can take any form, including wireline, satellite, wireless, or a combination thereof.

From a hardware standpoint, any of information devices 6200-6650 can be, for example, a landline or wireless telephone, facsimile, personal computer, personal information manager, personal digital assistant, handheld computer, data terminal, or other similar device.

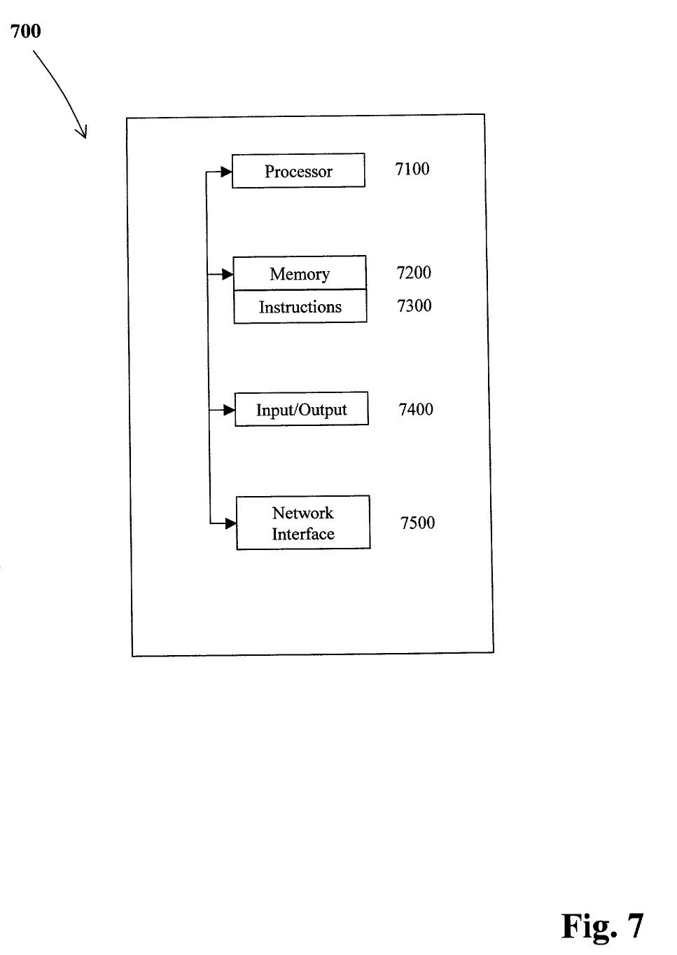

FIG. 7 is a block diagram of an embodiment of a typical information device 700, which can symbolize any information device 6200-6650, and/or data server 6700. Information device 700 can include well-known components such as one or more processors 7100, one or more memories 7200 containing one or more sets of instructions 7300, one or more input/output (I/O) devices 7400, and one or more network interfaces 7500.

In one embodiment, any processor 7100 can be a general purpose micro-processor, such a the Pentium series microprocessor manufactured by the Intel Corporation of Santa Clara, Calif. In another embodiment, any processor 7100 can be an Application Specific Integrated Circuit (ASIC), which has been designed to implement in its hardware and/or firmware at least a part of a method in accordance with an embodiment of the present invention.

Any memory 7200 can be coupled to a processor 7100 and can store instructions 7300 adapted to be executed by one or more processors 7100 according to one or more activities of any of methods 100-500. Any memory 7200 can be any device capable of storing analog or digital information, such as a hard disk, Random Access Memory (RAM), Read Only Memory (ROM), flash memory, a compact disk, a magnetic tape, a floppy disk, and any combination thereof.

Any set of instructions 7300 can be embodied in software, which can take any of numerous forms that are well-known in the art. For example, system 600 can utilize one or more databases having a flat file or a relational organization, and a centralized or distributed architecture. For instance, those of skill in the art can tailor items such as an SQL database to provide the functionality of any of methods 100-500 and system 600. One supplier of such database items is Oracle Corporation, of Redwood Shores, Calif. Moreover, software tools such as EDI, FTP, HTTP, HTML, XML, cXML, XSL, and WAP can be utilized for communications between information devices. Additionally, system 600 can utilize platform-independent and/or network-centric software tools such as, for example, Java or JavaScript.

Any input/output (I/O) device 7400 can be an audio and/or visual device, including, for example, a monitor, display, keyboard, keypad, touchpad, pointing device, microphone, speaker, video camera, camera, scanner, and/or printer, including a port to which an I/O device can be attached or connected.

Any network interface 7500 can be a telephone, a traditional data modem, a fax modem, a cable modem, a digital subscriber line interface, a bridge, a hub, a router, or other similar devices.

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and storage protocols, any formats for storing, transferring, and replaying music will suffice. Moreover, while some of the embodiments describe specific embodiments of memory media, any media, including digital and analog media, can be employed by the invention described herein. Furthermore, these examples should not be interpreted to limit the modifications and variations of the invention covered by the claims but are merely illustrative of possible variations.

What is claimed is:

1. A computer-assisted method for tracking a balance amount associated with a prepaid card for purchasing digital music, comprising:
via a processor, populating a database with a unique identifier associated with a prepaid card for purchasing digital music;
upon a sale of said prepaid card, associating an initial amount and a personal identifier with the unique identifier in the database;
upon receiving a card verification request, verifying said unique identifier;
upon receiving a personal verification request, verifying said personal identifier;
upon receiving a balance verification request, verifying a balance amount of said prepaid card; and
upon receiving transaction information regarding a transaction involving said prepaid card, adjusting said initial amount by a transaction amount corresponding to said transaction to create said balance amount.

2. The method according to claim 1, further comprising selling the prepaid card in response to receiving the initial amount.

3. The method according to claim 1, further comprising receiving the personal identifier.

4. A computer-readable medium containing instructions for activities comprising:
populating a database with a unique identifier associated with a prepaid card for purchasing digital music;
upon a sale of said prepaid card, associating an initial amount and a personal identifier with the unique identifier in the database;
upon receiving a card verification request, verifying said unique identifier;
upon receiving a personal verification request, verifying said personal identifier;
upon receiving a balance verification request, verifying a balance amount of said prepaid card; and
upon receiving transaction information regarding a transaction involving said prepaid card, adjusting said initial amount by a transaction amount corresponding to said transaction to create said balance amount.

5. A method for facilitating procurement of digital music with a prepaid card, comprising:
receiving from a purchaser an identification of a balance amount desired for a prepaid card for procuring digital music;
selling the prepaid card to the purchaser, the prepaid card including the identified balance amount and a unique identifier; and
registering the balance amount, unique identifier, and a personal identifier associated with the purchaser.

6. The method according to claim 6, further comprising entering the balance amount onto the prepaid card.

7. The method according to claim 6, further comprising providing one of a plurality of prepaid cards, the provided prepaid card having a pre-existing balance amount less than or equal to the identified balance amount.

8. The method according to claim 6, further comprising providing the unique identifier to the prepaid card.

9. The method according to claim 6, further comprising receiving the personal identifier from the purchaser.

10. A computer-assisted method for facilitating purchases of digital music with a prepaid card, comprising:
receiving the prepaid card as an instrument in a financial transaction involving digital music;
verifying that the prepaid card has a balance amount sufficient to complete the financial transaction; and
modifying the balance amount to reflect a transaction amount related to the financial transaction.

11. The method according to claim 10, further comprising reading the balance amount from the prepaid card.

12. The method according to claim 10, further comprising obtaining the balance amount from a database.

13. The method according to claim 10, further comprising reading a unique identifier associated with the prepaid card.

14. The method according to claim 10, further comprising sending a transaction amount to a database.

15. A method for procuring a prepaid card for obtaining digital music, comprising:
requesting a prepaid card for purchasing digital music;
selecting a balance amount for the prepaid card;
selecting a personal identifier for the prepaid card; and
procuring the prepaid card.

16. The method according to claim 15, further comprising receiving the prepaid card, the prepaid card being associated with the selected personal identifier.

17. The method according to claim 15, further comprising receiving the prepaid card, the prepaid card being associated with the selected balance amount.

18. A method for purchasing of digital music with a prepaid card, comprising:
providing a prepaid card to affect a transaction involving digital music, the prepaid card having a unique identifier, the transaction resulting in a modification to a balance amount associated with the prepaid card; and
providing a personal identifier associated with the prepaid card to authenticate said provision of the prepaid card.

19. The method according to claim 18, further comprising selecting digital music for the transaction and receiving the selected digital music in response to the transaction.

20. The method according to claim 18, further comprising receiving notification when the balance amount associated with the prepaid card is below a predetermined value.

21. A prepaid digital music procurement card, said card including a unique digital music procurement card identifier, a balance amount, and a personal identifier.
